(19) United States
(12) Patent Application Publication
(10) Pub. No.: US 2019/0153312 A1
(43) Pub. Date: May 23, 2019

(54) PHOTO-LUMINESCENT MATERIAL

(71) Applicant: RENGO CO., LTD., Osaka (JP)

(72) Inventors: Kouju SUGIYAMA, Osaka (JP); Toshikazu HANATANI, Osaka (JP); Kaoru YAMAGUCHI, Osaka (JP); Shinji FUJIKI, Osaka (JP); Minoru MATSUKURA, Tokyo (JP); Shogo FUJIWARA, Tokyo (JP); Akio TANIGUCHI, Nagoya (JP); Junichi UCHITA, Nagoya (JP)

(73) Assignee: RENGO CO., LTD., Osaka (JP)

(21) Appl. No.: 16/302,258

(22) PCT Filed: May 29, 2017
(86) PCT No.: PCT/JP2017/019874

§ 371 Date: Nov. 16, 2018

(30) Foreign Application Priority Data
May 30, 2016 (JP) 2016-107741

(51) Int. Cl. C09K 11/64; C01B 39/14; G02F 1/13357

(52) U.S. Cl. CPC C09K 11/646; G02F 2001/133614; G02F 1/1336; C01B 39/14

(57) ABSTRACT

The present invention provides a photoluminescent material emitting a visible light by irradiation of light, which is zeolite A comprising silver ion, zinc ion and at least one selected from the group consisting of cesium ion and rubidium ion.

### TECHNICAL FIELD

The present invention relates to a photoluminescent material. Here, the “photoluminescent material” means a “material used for an application utilizing photoluminescence (i.e., phenomenon of visible light emission by light irradiation)”.

### BACKGROUND ART

A photoluminescent material that emits visible light (generally, light with a wavelength of not less than 380 nm and less than 830 nm) by irradiation of light is used for lighting equipments, back light for liquid crystal display devices and the like. As such photoluminescent material, for example, patent document 1 describes zeolite A containing silver ion and zinc ion.

### DOCUMENT LIST

### Patent Document

patent document 1: JP-A-2014-37492

### SUMMARY OF THE INVENTION

### Problems to be Solved by the Invention

When a photoluminescent material is used in a lighting equipment, the emission intensity of the photoluminescent material sometimes decreases depending on the rise in the temperature of the environment used. For example, the temperature of the environment where a LED lighting equipment is used generally rises to about 60-70° C. When a photoluminescent material is used for such LED lighting equipment, the emission intensity of the photoluminescent material decreases in some cases.

The present invention has been made by taking note of the above-mentioned situation, and aims to provide a photoluminescent material that can suppress a decrease in the emission intensity due to a temperature rise.

### Means of Solving the Problems

The present inventors have conducted intensive studies in an attempt to solve the aforementioned problem and found that a decrease in the emission intensity due to a temperature rise can be suppressed by further adding at least one selected from the group consisting of cesium ion and rubidium ion to zeolite A containing silver ion and zinc ion described in patent document 1. The present invention based on this finding is as described below.

[1] A photoluminescent material emitting a visible light by irradiation of light, which is zeolite A comprising silver ion, zinc ion and at least one selected from the group consisting of cesium ion and rubidium ion.
[2] The photoluminescent material of the aforementioned [1], wherein the light to be irradiated has a wavelength of not less than 200 nm and not more than 450 nm.
[3] The photoluminescent material of the aforementioned [2], wherein the light to be irradiated has a wavelength of not less than 250 nm.
[4] The photoluminescent material of the aforementioned [2], wherein the light to be irradiated has a wavelength of not less than 280 nm.
[5] The photoluminescent material of any one of the aforementioned [2] to [4], wherein the light to be irradiated has a wavelength of not more than 440 nm.
[6] The photoluminescent material of any one of the aforementioned [2] to [4], wherein the light to be irradiated has a wavelength of not more than 430 nm.
[7] The photoluminescent material of any one of the aforementioned [1] to [6], wherein said at least one selected from the group consisting of cesium ion and rubidium ion is cesium ion.
[8] The photoluminescent material of any one of the aforementioned [1] to [7], wherein a total content of at least one selected from the group consisting of cesium ion and rubidium ion is not less than 1 wt % and not more than 25 wt %.
[9] The photoluminescent material of the aforementioned [8], wherein the total content of at least one selected from the group consisting of cesium ion and rubidium ion is not less than 1.5 wt %.
[10] The photoluminescent material of the aforementioned [8], wherein the total content of at least one selected from the group consisting of cesium ion and rubidium ion is not less than 2 wt %.
[11] The photoluminescent material of any one of the aforementioned [8] to [10], wherein the total content of at least one selected from the group consisting of cesium ion and rubidium ion is not more than 24 wt %.
[12] The photoluminescent material of any one of the aforementioned [8] to [10], wherein the total content of at least one selected from the group consisting of cesium ion and rubidium ion is not more than 23 wt %.
[13] The photoluminescent material of any one of the aforementioned [1] to [12], wherein a content of silver ion is not less than 0.5 wt % and not more than 30 wt %.
[14] The photoluminescent material of the aforementioned [13], wherein the content of silver ion is not less than 1 wt %.
[15] The photoluminescent material of the aforementioned [13], wherein the content of silver ion is not less than 1.5 wt %.
[16] The photoluminescent material of any one of the aforementioned [13] to [15], wherein the content of silver ion is not more than 29 wt %.
[17] The photoluminescent material of any one of the aforementioned [13] to [15], wherein the content of silver ion is not more than 28 wt %.
[18] The photoluminescent material of any one of the aforementioned [1] to [17], wherein a content of zinc ion is not less than 0.5 wt % and not more than 15 wt %.
[19] The photoluminescent material of the aforementioned [18], wherein the content of zinc ion is not less than 1 wt %.
[20] The photoluminescent material of the aforementioned [18], wherein the content of zinc ion is not less than 5 wt %.
[21] The photoluminescent material of any one of the aforementioned [18] to [20], wherein the content of zinc ion is not more than 14 wt %.
[22] The photoluminescent material of any one of the aforementioned [18] to [20], wherein the content of zinc ion is not more than 13 wt %.
[23] The photoluminescent material of any one of the aforementioned [1] to [22], wherein the zeolite A has a particle size of 0.1-20 μm.
[24] The photoluminescent material of any one of the aforementioned [1] to [22], wherein the zeolite A has a particle size of 0.5-10 μm.
[25] A lighting equipment comprising a light source and the photoluminescent material of any one of the aforementioned [1] to [24].
[26] The lighting equipment of the aforementioned [25], which is a back light for a liquid crystal display device.

### Effect of the Invention

The photoluminescent material of the present invention can suppress a decrease in the emission intensity due to a temperature rise as compared to the conventional photoluminescent material described in patent document 1.

### DESCRIPTION OF EMBODIMENTS

The photoluminescent material of the present invention characteristically further contains at least one selected from the group consisting of cesium ion and rubidium ion in the photoluminescent material described in patent document 1 (i.e., zeolite A containing silver ion and zinc ion). Big ions such as cesium ion and rubidium ion do not easily enter porous carriers such as zeolite and the like, and therefore, the aforementioned constitution of the present invention cannot be easily envisaged by those of ordinary, skill in the art from patent document 1.

As shown in the following Examples, a decrease in the emission intensity due to a temperature rise can be suppressed by further adding at least one selected from the group consisting of cesium ion and rubidium ion to zeolite A containing silver ion and zinc ion. As a mechanism achieving such effect, it is assumed that the movement of silver ion in zeolite A due to a temperature rise is limited by adding a big ion such as cesium ion and rubidium ion, and a decrease in the emission intensity is suppressed. However, the present invention is not limited to such assumed mechanism.

As shown in the following Examples, emission intensity itself can be improved surprisingly by adding at least one selected from the group consisting of cesium ion and rubidium ion to zeolite A containing silver ion and zinc ion.

The at least one selected from the group consisting of cesium ion and rubidium ion is preferably cesium ion.

The total content of at least one selected from the group consisting of cesium ion and rubidium ion (when only one is used, the content thereof) in the photoluminescent material is preferably not less than 1 wt %, more preferably not less than 1.5 wt %, further preferably not less than 2 wt %, preferably not more than 25 wt %, more preferably not more than 24 wt %, further preferably not more than 23 wt %. These contents can be measured by the method shown in the following Examples or a method analogous thereto.

The content of silver ion in the photoluminescent material is preferably not less than 0.5 wt %, more preferably not less than 1 wt %, further preferably not less than 1.5 wt %, preferably not more than 30 wt %, more preferably not more than 29 wt %, further preferably not more than 28 wt %. The content can be measured by the method shown in the following Examples or a method analogous thereto.

The content of zinc ion in the photoluminescent material is preferably not less than 0.5 wt %, more preferably not less than 1 wt %, further preferably not less than 5 wt %, preferably not more than 15 wt %, more preferably not more than 14 wt %, further preferably not more than 13 wt %. The content can be measured by the method shown in the following Examples or a method analogous thereto.

The photoluminescent material of the present invention may contain an ion other than the aforementioned ions (hereinafter sometimes to be referred to as “other ion”), as long as the effect of the present invention is not inhibited. Only one kind of other ion may be used or two or more kinds may be used. Examples of such other ion include ammonium ion, sodium ion, potassium ion, calcium ion, magnesium ion and the like.

The photoluminescent material of the present invention can be produced by ion exchange of zeolite A as mentioned below. Therefore, other ion may be an ion that the original zeolite A contained before ion exchange (e.g., sodium ion etc.). Alternatively, other ion may be introduced into the photoluminescent material of the present invention by ion exchange using an aqueous solution containing the other ion.

Zeolite A used in the present invention is commercially available from UNION SHOWA K.K. and can be easily obtained. The particle size of zeolite A is preferably 0.1-20 μm, more preferably 0.5-10 μm. The particle size thereof can be measured by laser diffraction and a laser scattering method. For the measurement, for example, a laser diffraction particle size analyzer: “SALD-2100” manufactured by SHIMADZU Corporation and the like can be used.

Whether zeolite contained in the photoluminescent material is zeolite A can be judged by a structural analysis of diffraction peak measured by powder X-ray diffractometry, a structural analysis of MAS (Magic-Angle Spinning) NMR spectrum measured by solid-state NMR or the like.

The photoluminescent material of the present invention can be produced by ion exchange of zeolite A, as shown in the following Examples. The method for ion exchange is not particularly limited. For example, ion exchange can be performed at once by stirring and maintaining zeolite A in an aqueous solution containing all of at least one selected from the group consisting of cesium ion and rubidium ion, silver ion and zinc ion, and other ion as necessary. In addition, zeolite A may be stirred and maintained in each of an aqueous solution containing at least one selected from the group consisting of cesium ion and rubidium ion, an aqueous solution containing silver ion, an aqueous solution containing zinc ion, and an aqueous solution containing other ion as necessary, to successively perform ion exchange. When the photoluminescent material of the present invention is produced by successive ion exchange, the order of ion exchange is not particularly limited.

Examples of the source of cesium ion to be used for ion exchange include cesium nitrate. Examples of the source of rubidium ion include rubidium nitrate. Examples of the source of silver ion include silver nitrate. Examples of the source of zinc ion include zinc sulfate, zinc nitrate.

As shown in the following Examples, the concentration of each ion in the aqueous solution can be adjusted as appropriate according to the design value of the content of each ion in the photoluminescent material of the present invention. Ion exchange can be performed at room temperature and the time thereof (i.e., time of stirring and maintaining zeolite A in aqueous solution containing ion) is preferably not less than 30 min, more preferably not less than 1 hr, preferably not more than 10 hr, more preferably not more than 5 hr.

Zeolite A containing cesium ion and the like after ion exchange is preferably collected by filtration from the ion-containing aqueous solution, washed with water and dried. Drying can be performed under air atmosphere in an inert gas (e.g., nitrogen gas) atmosphere or reduced-pressure atmosphere. Drying under air atmosphere is preferable since the operation can be performed conveniently. The drying temperature is preferably not less than 50° C., more preferably not less than 100° C., preferably not more than 150° C., more preferably not more than 120° C. The drying time is preferably not less than 1 hr, more preferably not less than 2 hr, preferably not more than 30 hr, more preferably not more than 20 hr.

Zeolite A containing cesium ion and the like after drying can be further subjected to a heat treatment. Heating can be performed under air atmosphere in an inert gas (e.g., nitrogen gas) atmosphere or reduced-pressure atmosphere. Heating under air atmosphere is preferable since the operation can be performed conveniently. The heating temperature is preferably not less than 180° C., more preferably not less than 200° C., preferably not more than 300° C., more preferably not more than 250° C. The heating time is preferably not less than 1 hr, more preferably not less than 2 hr, preferably not more than 10 hr, more preferably not more than 5 hr.

The wavelength of the light to be irradiated on the photoluminescent material of the present invention is preferably not less than 200 nm, more preferably not less than 250 nm, further preferably not less than 280 nm, and preferably not more than 450 nm, more preferably not more than 440 nm, further preferably not more than 430 nm. The photoluminescent material of the present invention can emit visible light when light in the visible light region having a wavelength of not less than 380 nm is irradiated as well as light in the ultraviolet light region having a wavelength of less than 380 nm.

The photoluminescent material of the present invention to be used may be of one kind or two or more kinds in combination. Also, the photoluminescent material of the present invention may be used in combination with other photoluminescent material. The photoluminescent material of the present invention can be utilized for, for example, lighting equipment, luminescent paint, luminescent fiber, resin-molded products, luminescence element, sensor and the like.

The present invention also provides a lighting equipment containing a light source and the photoluminescent material of the present invention. In the lighting equipment of the present invention, known light sources, for example, a mercury lamp and an LED can be used. As the light source, LED is preferable since it shows high energy efficiency and does not use mercury that causes environmental contamination.

The lighting equipment of the present invention can be used as lights for daily living such as fluorescent lamp, back light for a liquid crystal display device and the like.

The method of use of a photoluminescent material in a lighting equipment is not particularly limited. For example, a light source may be covered with glass, and the photoluminescent material may be fixed on the inside or outside the glass with a binder (e.g., transparent epoxy resin). Moreover, a light source may be covered with glass kneaded with the photoluminescent material of the present invention. Furthermore, a lighting equipment emitting a subdued light such as that of an oil lamp stand with a wood frame and paper shade can be produced by covering a light source with paper kneaded with the photoluminescent material of the present invention.

### EXAMPLE

The present invention is explained in more detail in the following by referring to Examples, which are not to be construed as limitative. It is possible to modify and practice the invention as long as it does not deviate from the above-mentioned and the following descriptions, and all such embodiments are encompassed in the technical scope of the present invention. In the following, zeolite A containing silver ion and zinc ion is abbreviated as “silver/zinc ion-containing zeolite A”, and zeolite A containing silver ion, zinc ion and cesium ion is abbreviated as “silver/zinc/cesium ion-containing zeolite A”.

### Comparative Example 1: Silver/Zinc Ion-Containing Zeolite A

zeolite A (manufactured by UNION SHOWA K.K., trade name “Molecular Sieve 4A POWDER”, particle size: about 5 μm, containing sodium ion as cation for ion exchange, ion exchange capacity: about 5.5 meq/g). (5 g) was stirred and maintained in an aqueous solution (500 mL) of silver nitrate and nitrate zinc in mixture of at room temperature for 1 hr, whereby an exchange treatment of silver ion and zinc ion was performed. To respectively set a silver ion content and a zinc ion content of the obtained silver/zinc-containing zeolite A to 2.2 wt % and 8.8 wt %, the concentration of silver nitrate in the aqueous mixed solution was adjusted to 2.74 mmol/L and the concentration of nitrate zinc 6 hydrate in the aqueous mixed solution was adjusted to 19.18 mmol/L. Then, silver/zinc ion-containing zeolite A suspended in water was collected by filtration and washed with water to give wet silver/zinc ion-containing zeolite A. The silver/zinc ion-containing zeolite A after washing with water was dried in an air atmosphere at 105° C. for 16 hr to give dried silver/zinc ion-containing zeolite A. The dried silver/zinc ion-containing zeolite A was maintained in an environment of 23° C., relative humidity 50% for 24 hr and allowed to cool to give silver/zinc ion-containing zeolite A.

Using JSM-6010PLUS/LA manufactured by JEOL Ltd., the photoluminescent material (silver/zinc ion-containing zeolite A) obtained in Comparative Example 1 was subjected to an energy dispersive X-ray analysis (EDS, acceleration voltage 15 kV), and the contents of silver ion and zinc ion were measured. The contents thereof are shown in Table 1.

### Example 1: Silver/Zinc/Cesium Ion-Containing Zeolite A

Silver/zinc ion-containing zeolite A (5 g) obtained in the same manner as in Comparative Example 1 was stirred and maintained in an aqueous nitrate cesium solution (500 mL) at room temperature for 1 hr to perform a cesium ion exchange treatment. To set a cesium ion content of the obtained silver/zinc/cesium ion-containing zeolite A to 4.0 wt %, the concentration of nitrate cesium in the aqueous solution was adjusted to 5.48 mmol/L. Then, silver/zinc/cesium ion-containing zeolite A suspended in water was collected by filtration and washed with water to give wet silver/zinc/cesium ion-containing zeolite A. The silver/zinc/cesium ion-containing zeolite A after washing with water was dried in an air atmosphere at 105° C. for 16 hr to give dried silver/zinc/cesium ion-containing zeolite A. The dried silver/zinc/cesium ion-containing zeolite A was maintained in an environment of 23° C., relative humidity 50% for 24 hr and allowed to cool to give silver/zinc/cesium ion-containing zeolite A.

Using JSM-6010PLUS/LA manufactured by JEOL Ltd., the photoluminescent material (silver/zinc/cesium ion-containing zeolite A) obtained in Example 1 was subjected to an energy dispersive X-ray analysis (EDS, acceleration voltage 15 kV), and the contents of silver ion, zinc ion and cesium ion were measured. The contents thereof are shown in Table 1.

### Example 2: Silver/Zinc/Cesium Ion-Containing Zeolite A

Silver/zinc ion-containing zeolite A (5 g) obtained in the same manner as in Comparative Example 1 was subjected to a cesium ion exchange treatment in an aqueous nitrate cesium solution in the same manner as in Example 1. To set a cesium ion content of the obtained silver/zinc/cesium ion-containing zeolite A to 16.6 wt %, the concentration of nitrate cesium in the aqueous solution was adjusted to 109.6 mmol/L. Then, in the same manner as in Example 1, treatments for filtration, washing with water, drying and allowing to cool were performed to give silver/zinc/cesium ion-containing zeolite A.

The contents of silver ion, zinc ion and cesium ion in the photoluminescent material (silver/zinc/cesium ion-containing zeolite A) obtained in Example 2 were measured in the same manner as in Example 1. The contents thereof are shown in Table 1.

### Experimental Example 1

The luminescent starting wavelength, peak wavelength and ending wavelength of the photoluminescent materials of Comparative Example 1 and Examples 1 and 2 were measured using fluorescence spectrophotometer FluoroMax-4 manufactured by Horiba, Ltd. When an excitation light with a wavelength of 420 nm was irradiated, the luminescent starting wavelength, peak wavelength and ending wavelength of the photoluminescent materials of Comparative Example 1, Example 1 and Example 2 were respectively 450 nm, 650 nm and 750 nm.

### Experimental Example 2

Using fluorescence spectrophotometer FluoroMax-4 manufactured by Horiba, Ltd., the emission peak intensity at 25° C. of the photoluminescent materials of Comparative Example 1 and Examples 1 and 2 upon irradiation of the same excitation light (wavelength: 420 nm) was measured, and the rate (%) of the emission peak intensity of the photoluminescent material of Example 1 or 2 to the emission peak intensity of the photoluminescent material of Comparative Example 1 (=100×emission peak intensity of photoluminescent material of Example 1 or 2/emission peak intensity of photoluminescent material of Comparative Example 1) was calculated. The results are shown in Table 1.

### Experimental Example 3

Using fluorescence spectrophotometer FluoroMax-4 manufactured by Horiba, Ltd., the emission peak intensity at 25° C. and 75° C. of the photoluminescent materials of Comparative Example 1 and Examples 1 and 2 upon irradiation of the same excitation light (wavelength: 420 nm) was measured, and the rate (%) of the emission peak intensity of the photoluminescent material at 75° C. to the emission peak intensity of the photoluminescent material at 25° C. (=100×emission peak intensity of photoluminescent material at 75° C./emission peak intensity of photoluminescent material at 25° C.) was calculated for each of the photoluminescent materials of Comparative Example 1 and Examples 1 and 2. The results are shown in Table 1.

TABLE 1

| | content (wt %) | | | rate 1 | rate 2 |
|---|---|---|---|---|---|
| | Ag⁺ | Zn²⁺ | Cs⁺ | (%) | (%) |
| Comparative Example 1 | 2.2 | 8.8 | — | — | 54.8 |
| Example 1 | 2.0 | 9.4 | 4.0 | 172 | 74.8 |
| Example 2 | 1.7 | 8.6 | 16.6 | 501 | 90.5 |

(note)
rate 1 = rate of emission peak intensity of photoluminescent material of Example 1 or 2 to emission peak intensity of photoluminescent material of Comparative Example 1
rate 2 = rate of emission peak intensity of photoluminescent material at 75° C. to emission peak intensity of photoluminescent material at 25° C.

As the results of rate 2 described in Table 1 show, a decrease in the emission intensity at a high temperature (75° C.) can be suppressed by further adding cesium ion to silver/zinc ion-containing zeolite A. In addition, as the results of rate 1 described in Table 1 show, the emission intensity itself can be improved by further adding cesium ion.

### INDUSTRIAL APPLICABILITY

The photoluminescent material of the present invention can be utilized for lighting equipment, luminescent paint and the like.

This application is based on a patent application No. 2016-107741 filed in Japan, the contents of which are incorporated in full herein.

1. A photoluminescent material emitting a visible light by irradiation of light, which is zeolite A comprising silver ion, zinc ion and at least one selected from the group consisting of cesium ion and rubidium ion.

2. The photoluminescent material according to claim 1, wherein the light to be irradiated has a wavelength of not less than 200 nm and not more than 450 nm.

3. The photoluminescent material according to claim 2, wherein said at least one selected from the group consisting of cesium ion and rubidium ion is cesium ion.

4. The photoluminescent material according to claim 3, wherein a total content of at least one selected from the group consisting of cesium ion and rubidium ion is not less than 1 wt % and not more than 25 wt %.

5. The photoluminescent material according to claim 4, wherein a content of silver ion is not less than 0.5 wt % and not more than 30 wt %.

6. The photoluminescent material according to claim 5, wherein a content of zinc ion is not less than 0.5 wt % and not more than 15 wt %.

7. A lighting equipment comprising a light source and the photoluminescent material according to claim 1.

8. The lighting equipment according to claim 7, which is a back light for a liquid crystal display device.

9. A lighting equipment comprising a light source and the photoluminescent material according to claim to claim 6.

10. The lighting equipment according to claim 9, which is a back light for a liquid crystal display device.

11. The photoluminescent material according to claim 1, wherein said at least one selected from the group consisting of cesium ion and rubidium ion is cesium ion.

12. The photoluminescent material according to claim 1, wherein a total content of at least one selected from the group consisting of cesium ion and rubidium ion is not less than 1 wt % and not more than 25 wt %.

13. The photoluminescent material according to claim 1, wherein a content of silver ion is not less than 0.5 wt % and not more than 30 wt %.

14. The photoluminescent material according to claim 1, wherein a content of zinc ion is not less than 0.5 wt % and not more than 15 wt %.
